(19) United States
(12) Patent Application Publication
(10) Pub. No.: US 2010/0167663 A1
(43) Pub. Date: Jul. 1, 2010

(54) Mobile Communication Device and Communication Method Thereof

(75) Inventors: PAN-YEN CHIANG, Hsinchu Hsien (TW); TSUNG-HSUN MO, Hsinchu Hsien (TW); CHENG FENG CHUNG, Hsinchu Hsien (TW); YUH-HWANG YOU, Hsinchu Hsien (TW)

Correspondence Address: WPAT, PC;INTELLECTUAL PROPERTY ATTORNEYS, 7225 BEVERLY ST., ANNANDALE, VA, 22003, US

(73) Assignee: MSTAR SEMICONDUCTOR, INC., Hsinchu Hsien (TW)

(21) Appl. No.: 12/484,334

(22) Filed: Jun. 15, 2009

(30) Foreign Application Priority Data
Dec. 29, 2008 (TW) 097151293

(51) Int. Cl. H04B 7/00

(52) U.S. Cl. 455/69

(57) ABSTRACT

A mobile communication device is provided. The mobile communication device comprises a radio frequency (RF) module, a first communication module, a second communication module and a control module. The RF module is used to transmit and receive RF signals. The first communication module utilizes the RF module to establish a first communication connection. The second communication module utilizes the RF module to establish a second communication connection. The control module arbitrates requests to access the RF module from the first communication module and the second communication module.

### CROSS REFERENCE TO RELATED PATENT APPLICATION

This patent application is based on a Taiwan, R.O.C. patent application No. 97151293 filed on Dec. 29, 2008.

### FIELD OF THE INVENTION

The present invention relates to a mobile communication device and a method thereof, and more particularly, to a mobile communication device supporting more than one Subscriber Identity Module (SIM) cards and a method thereof.

### BACKGROUND OF THE INVENTION

The invention of mobile phones allows people to communicate with each other anytime and anywhere. With the increasing popularity of mobile phones, more and more subscribers have two or more SIM cards. Each of the SIM cards represents a unique phone number. Therefore, a user has to simultaneously carry several mobile phones to answer phone calls or short messages of different phone numbers.

In order to solve the problem that the user has to carry several mobile phones, a dual card mobile phone is provided. The dual card mobile phone has two SIM cards, and two software communication modules therein share a radio frequency (RF) module in order to use two phone numbers.

However, when two communication modules share an RF module in the dual card mobile phone, synchronization and race condition issues are easily incurred. Furthermore, each of the communication modules has different management units, such as a radio resource (RR) management unit, a mobile management (MM) unit and a connection management (CM) unit, and tasks of the management units have different task priorities. The task nearer to the management unit of the RF module has a higher task priority, and the task nearer to the management unit of a user interface has a lower task priority. For example, when a message is transmitted from a communication module via the user interface by the user and a phone call is simultaneously received by another communication module via the RF module, the synchronization and race condition issues are incurred for the reason that the tasks have different task priorities.

### SUMMARY OF THE INVENTION

The present invention relates to a mobile communication device and a communication method thereof. The mobile communication device utilizes a control module to avoid synchronization and race condition issues incurred when two communication modules of the mobile communication device share an RF module.

A mobile communication device is provided according to the present invention. The mobile communication device comprises an RF module, a first communication module, a second communication module and a control module. The RF module transmits and receives RF signals. The first communication module utilizes the RF module to establish a first communication connection. The second communication module utilizes the RF module to establish a second communication connection. The control module arbitrates requests to access the RF module from the first communication module and the second communication module.

A communication method is provided according to the present invention. The method is applied to a mobile communication device comprising a first communication module, a second communication module, an RF module and a control module. The communication method comprises steps below. In step (a), when the first communication module wants to use the RF module, a request signal is transmitted to the control module to request for the authority of operating the RF module. In step (b), whether the first communication module receives a grant signal from the control module is determined. In step (c), upon receiving the grant signal, the first communication module is allowed to operate the RF module and the second communication module is suspended.

The advantages and spirit related to the present invention can be further understood via the following detailed description and drawings.

### BRIEF DESCRIPTION OF THE DRAWINGS

FIG. 1 is a functional block of a mobile communication device in accordance with an embodiment of the present invention.

FIG. 2 is a structure diagram of a mobile communication device in accordance with a preferred embodiment of the present invention.

FIG. 3 is a flow chart of a communication method of a mobile communication device in accordance with a preferred embodiment of the present invention.

### DETAILED DESCRIPTION OF THE PREFERRED EMBODIMENT

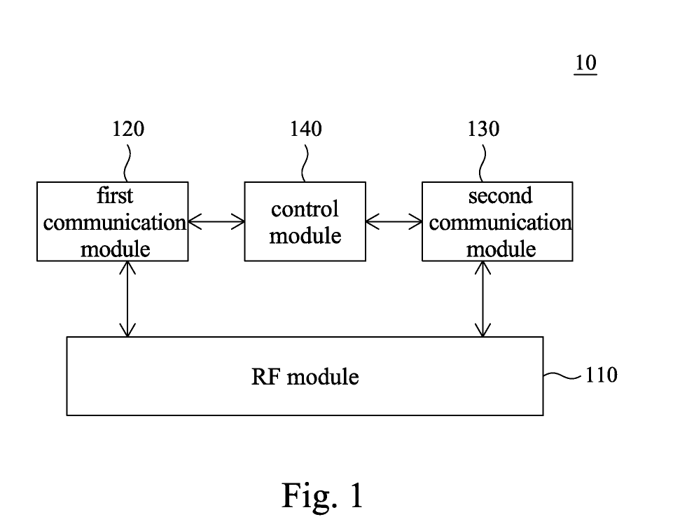

Refer to FIG. 1 showing a functional block of a mobile communication device in accordance with an embodiment of the present invention. A mobile communication device 10 comprises an RF module 110, a first communication module 120, a second communication module 130 and a control module 140. The RF module 110 is used to transmit and receive RF signals. The first communication module 120 utilizes the RF module 110 to establish a first communication connection. The second communication module 130 utilizes the RF module 110 to establish a second communication connection. The control module 140 is used to control the authority of operating the RF module 110 for the first communication module 120 and the second communication module 130.

Moreover, the foregoing mobile communication device supports several SIM cards and accordingly has several communication modules. Each of the communication modules establishes a connection with a base station via the RF module according to an identification data stored in a SIM card. The first communication module 120 and the second communication module 130 are used as an example to conveniently describe an embodiment of the present invention. However, the mobile communication device can provide more communication modules to operate the RF module 110 according to the number of the SIM cards. For example, the foregoing first communication module 120 and second communication module 130 are composed of software. When wanting to operate the RF module 110, the first communication module 120 or the second communication module 130 requests the authority of operating the RF module 110 from the control module 140. In this embodiment, the control module 140 uses a token to represent the authority of operating the RF module 110, and the token is a mark recorded in the control module 140. The first communication module 120 or the second communication module 140 requests the token from the control module 140 via a message mailbox or a function call. The control module 140 utilizes the token to control the authority of operating the RF module 110 for the first communication module 120 and the second communication module 130.

When the first communication module 120 or the second communication module 130 requests the token from the control module 140, the requesting communication module disables an interrupt function of the communication module during the period of waiting for a response from the control module 140, so as to prevent context switching. After receiving the response from the control module 140, the requesting communication module enables the foregoing interrupt function. In addition, once one of the competing communication modules obtains the token, the control module 140 broadcasting a suspend signal to all other communication modules without the token.

For example, when the first communication module 120 wants to operate the RF module 110, the first communication module 120 makes a request for the token to the control module 140, and disables the interrupt function of itself during the period of waiting for the response from the control module 140. The control module 140 then determines whether to give the token to the first communication module 120 according to the present situation of operating the RF module 110. Preferably, when receiving the request that the first communication module 120 wants to operate the RF module 110, the control module 140 determines the usage situation of the RF module 110 according to the situation of the token. For instance, when the control module 140 has given out the token, i.e., the control module 140 has a mark of the token, it means that the RF module 110 is being used at present; otherwise, when the control module 140 does not have the mark of the token, it means that the RF module 110 is not being used at present. When the control module 140 does not have the mark of the token, the control module 140 can generate a token, record the token therein, and transmit a grant signal to the first communication module 120 to inform that the first communication module 120 has obtained the token. When receiving the response from the control module 140, regardless of whether the token is obtained, the first communication module 120 enables the foregoing interrupt function. When obtaining the token representing the authority of operating the RF module 110, the first communication module 120 is allowed to operate the RF module 110. At this time, the control module 140 transmits a suspend signal to the second communication module 130. Therefore, an object of informing the situation of operating the RF 110 to the second communication module 130 in time is achieved, and the problem of a system crash in the mobile communication device 10 for the reason of false actions of the second communication module 130 is avoided. Furthermore, when receiving the suspend signal, the second communication module 130 enters a suspend state to maintain the current state. When the RF module 110 is no longer operated by the first communication module 120, the first communication module 120 informs the control module 140 that it stopped operating the RF module 110 in order to cancel the token mark inside the control module 140, which then becomes ready to receive a request for operating the RF module 110 again. The first communication module 120 also sends a message to inform the second communication module 130 that it stopped operating the RF module 110 to end the suspend state of the second communication module 130. In another embodiment, upon receiving the message that the first communication module 120 stopped operating the RF module 110, the control module 140 informs the second communication module 130 to end the suspend state.

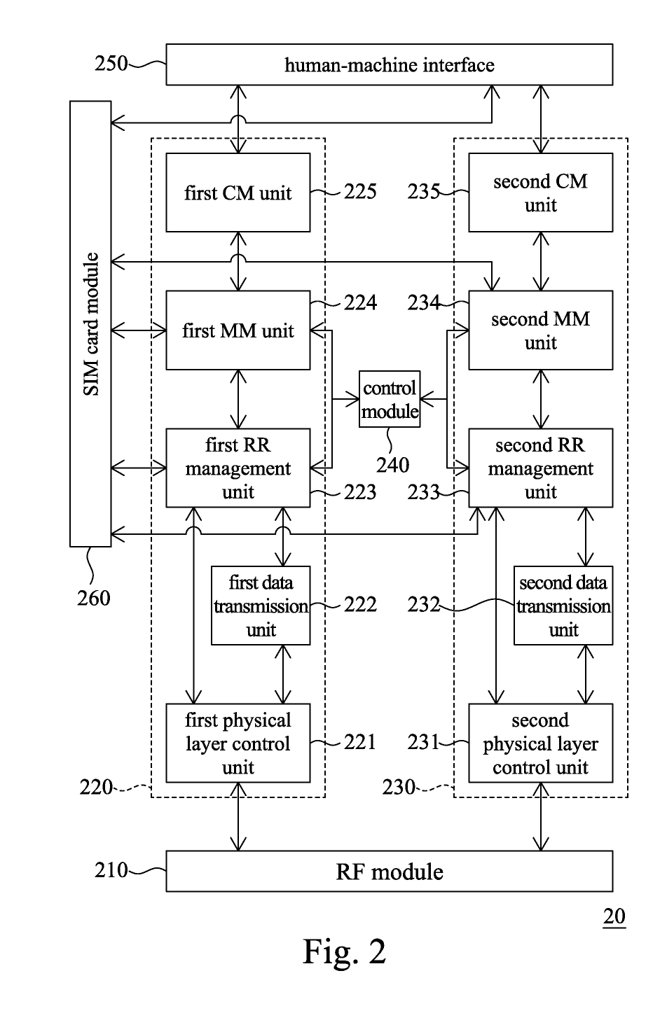

Refer to FIG. 2 showing a structure diagram of another embodiment of a mobile communication device according to the present invention. The mobile communication device 20 comprises an RF module 210, a first communication module 220, a second communication module 230, a control module 240, a human-machine interface 250 and a SIM card module 260. The first communication module 220 comprises a first physical layer control unit 221, a first data transmission unit 222, a first RR management unit 223, a first MM unit 224 and a first CM unit 225. The second communication module 230 comprises a second physical layer control unit 231, a second data transmission unit 232, a second RR management unit 233, a second MM unit 234 and a second CM unit 235. For example, the first physical layer control unit 221 and the second physical layer control unit 231 are Layer 1 (L1) of a communication protocol. The Layer 1 controls a physic layer of the foregoing mobile communication device 20. For example, the physic layer can include the foregoing RF module 210. The first data transmission unit 222 and the second data transmission unit 232, such as a Layer 2 (L2) of a communication protocol, are used for transmitting a point-to-point data.

The first RR management unit 223 and the second RR management unit 233 control the radio resource of the mobile communication device 20, such as to establish a connection with a communication network. The first MM unit 224 and the second MM unit 234 control the mobile management of the mobile communication device 20, such as registering to a communication network. The first CM unit 225 and the second CM unit 235, such as connection management of a communication protocol, are used for sending phone calls and messages.

The SIM card module 260 can support two SIM cards (not shown). The mobile communication device 20 can respectively utilize the two SIM cards to register to a mobile communication network via the first communication module 220 and the second communication module 230. A user of the mobile communication device 20 can control the mobile communication device 20 via the human-machine interface 250. For instance, the user utilizes the human-machine interface 250 to make a phone call or send a message.

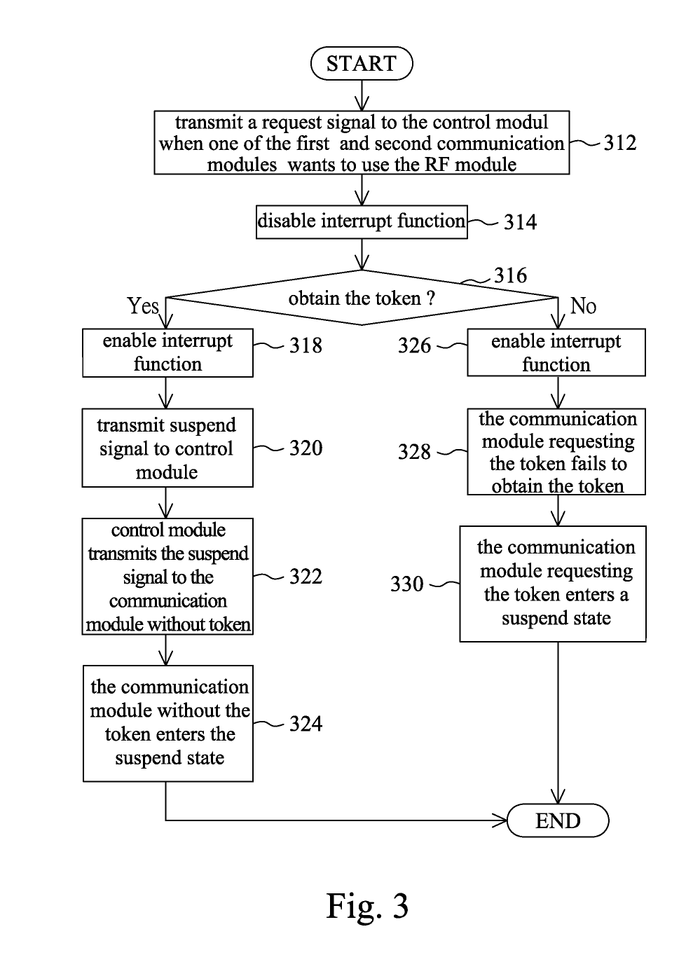

Simultaneously refer to FIG. 2 and FIG. 3 showing a flow chart of a communication method of a mobile communication device in accordance with a preferred embodiment of the present invention. In step 312, when one of the first communication module 220 and the second communication module 230 wants to operate the RF module 210 to establish a connection with a network, a request signal is transmitted to the control module 240 via a message mailbox or a function call of a communication module of the RF module 210, so as to request a token from the control module 240. For example, when the first communication module 220 wants to operate the RF module 210 to establish a connection with a network, the first RR management unit 223 requests the token from the control module 240 via the request signal.

In step 314, during the period of waiting for a response from the control module 240, an interrupt function of the communication module requesting the token is disabled to prevent context switching. In step 316, whether the requesting communication module has obtained the token is determined. When the answer is yes, step 318 is performed; otherwise, step 326 is performed.

In step 318, after having obtained the token, the communication module that requested for the token enables the foregoing interrupt function. In step 320, the communication module having the token transmits a suspend signal to the control module 240. In step 322, the control module 240 transmits the suspend signal to the communication module that does not obtained the token. In step 324, the communication module without the token receives the suspend signal and enters a suspend state to prevent synchronization and race condition issues. In another embodiment, after granting the token to one of the communication modules, the control module 240 can actively transmit the suspend signal to the other communication module.

For instance, when the first communication module 220 request the token, a suspend signal is transmitted to the control module 240 after the first RR management unit 223 obtains the token. The control module 240 then transmits the suspend signal to the second RR management unit 233 or the second MM unit 234. After receiving the suspend signal, the second RR management unit 233 or the second MM unit 234 enters the suspend state.

On the contrary, when the second communication module 230 requests the token, the suspend signal is transmitted to the control module 240 after the second RR management unit 233 obtains the token. The control module 240 then transmits the suspend signal to the first RR management unit 223 or the first MM unit 224. After receiving the suspend signal, the first RR management unit 223 or the first MM unit 224 enters the suspend state.

In step 326, when the communication module requesting the token does not obtain the token, the foregoing interrupt function is enabled. In step 328, if requesting the communication module fails to obtain the token, it means that the other communication module has obtained the authority of operating the RF module 210 and the requesting communication module has not yet received a suspend signal. In step 330, the requesting communication module enters a suspend state after receiving the suspend signal to prevent the synchronization and race condition issues.

For example, if the first communication module 220 requests the token and does not obtain the token, it means that the second communication module 230 has obtained the authority of operating the RF module 210, but the first RR management unit 223 or the first MM unit 224 of the first communication module has not yet received the suspend signal. After receiving the suspend signal, the first RR management unit 223 or the first MM unit 224 enters the suspend state.

On the contrary, if the second communication module 230 requests the token and does not obtain the token, it means that the first communication module 220 has obtained the authority of operating the RF module 210, but the second RR management unit 233 or the second MM unit 234 of the first communication module has not yet received the suspend signal. After receiving the suspend signal, the second RR management unit 233 or the second MM unit 234 enters the suspend state.

According to the foregoing embodiments of the present invention, a mobile communication device and a communication method thereof disclosed utilize the control module to control the authority of operating the RF module, so as to prevent synchronization and race condition issued incurred when two communication modules of the mobile communication device share an RF module.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A communication method of a mobile communication device, the mobile communication device comprising a first communication module, a second communication module, a radio frequency (RF) module and a control module, the communication method comprising steps of:
(a) transmitting a request signal to the control module to request operating the radio frequency module by the first communication module;
(b) determining whether the first communication module receives a grant signal from the control module; and
(c) when the first communication module receives the grant signal, allowing the first communication module to operate the radio frequency module and suspending the second communication module.

2. The communication method as claimed in claim 1, further comprising:
when the first communication module does not receive the grant signal, suspending the first communication module.

3. The communication method as claimed in claim 1, wherein the step (a) further comprises:
during a period of waiting for the grant signal, disabling an interrupt function of the first communication module.

4. The communication method as claimed in claim 3, wherein the step (c) further comprises:
enabling the interrupt function; and
transmitting a suspend signal to the second communication module to suspend the second communication module.

5. The communication method as claimed in claim 4, wherein the suspend signal is transmitted by the first communication module.

6. The communication method as claimed in claim 4, wherein the suspend signal is transmitted to the second communication module via the control module.

7. The communication method as claimed in claim 1, wherein the first communication module transmits the request signal via a function call in the step (a).

8. The communication method as claimed in claim 1, wherein the first communication module and the second communication module are composed of software.

9. A mobile communication device, comprising:
a radio frequency module, for transmitting a radio frequency signal;
a first communication module, for establishing a first communication connection through the radio frequency module;
a second communication module, for establishing a second communication connection through the radio frequency module; and
a control module, for arbitrating requests to access the radio frequency module from the first communication module and the second communication module.

10. The mobile communication device as claimed in claim 9, wherein the first communication module establishes the first communication connection according to a first subscriber identification module (SIM) card, and the second communication module establishes the second communication connection according to a second SIM card.

11. The mobile communication device as claimed in claim 9, wherein the first communication module requests the control module to access the radio frequency module.

12. The mobile communication device as claimed in claim 11, wherein after requesting the control module to access the radio frequency module and during a period of waiting for a response from the control module, the first communication module disables an interrupt function.

13. The mobile communication device as claimed in claim 12, wherein after receiving the response from the control module, the first communication module enables the interrupt function.

14. The mobile communication device as claimed in claim 11, wherein after the first communication module obtains an authority to access the radio frequency module, the control module transmits a suspend signal to the second communication module.

15. The mobile communication device as claimed in claim 11, wherein the first communication module requests the control module to access the radio frequency module via a function call.

16. The mobile communication device as claimed in claim 9, wherein the first communication module comprises a first radio resource (RR) management unit and a first mobile management (MM) unit, and the second communication module comprises a second RR management unit and a second MM unit.
